(19) United States
(12) Patent Application Publication
(10) Pub. No.: US 2021/0162578 A1
(43) Pub. Date: Jun. 3, 2021

(54) Portable Multifunctional Handle

(71) Applicant: Guixing Liu, Yangjiang (CN)

(72) Inventor: Guixing Liu, Yangjiang (CN)

(21) Appl. No.: 16/699,555

(22) Filed: Nov. 30, 2019

(51) Int. Cl. B25G 3/30

(52) U.S. Cl. CPC B25G 3/30

(57) ABSTRACT

A portable multifunctional handle, comprising first handle, one end of the first handle is connected with second handle, one end of the second end is connected with third handle, one end of the third handle is connected with functional tools; a fixing portion is provided on one end of the first handle near the second handle; a fastening piece is provided on outer side wall of fixing portion, an extension portion is fixed on one end of the first handle away from fixing portion, a hanging ring is arranged on extension portion; the first handle, fixing portion and extension portion are integrated design; the second and the third handle are connected by clamping, fastening or thread; the first, the second and the third handle are cylindrical; two sides of extension portion are symmetrically arranged with connecting hole, the hanging ring is fastened in the connecting holes.

### BACKGROUND OF THE INVENTION

### 1. Field of the Invention

The invention relates to the technical field of kitchen utensils, in particular to a portable multifunctional handle.

### 2. Description of the Related Art

With the improvement of living conditions and quality of life, people pay more and more attention to the diet. As tools that are often used, kitchen utensils are highly requirements on convenience and comfort. The prior handles on barbecue brush, kitchen cleaning brush or shovel etc are generally fixed handles, for brush head is easily consumable, while the handle has a relatively long service life, it is often the case that the brush head or other functional tool head is damaged but the handle is still intact, at this time, the handle has to be abandoned together with the damaged head, and a new tool is replaced as a whole, which may result in huge waste of resources, not only increase the cost but also put pressure on the earth resources.

Currently there is no multifunctional handle with simple structure and convenient replacement on the market, therefore, it is necessary to develop a multifunctional handle which has a wide range of applications can be used in a variety of tools.

### SUMMARY OF THE INVENTION

In order to solve exiting problems mentioned above, the invention provides a portable multifunctional handle. The invention can be achieved by following technical scheme.

A portable multifunctional handle, comprising a first handle, one end of the first handle is fixedly connected with a second handle, one end of the second end is detachably connected with a third handle, one end of the third handle is fixedly connected with functional tools; a fixing portion is provided on one end of the first handle near the second handle; the outer side wall of the fixing portion is fixedly connected with a fastening piece, an extension portion is fixed on one end of the first handle away from the fixing portion, a hanging ring is flexibly arranged on the extension portion; the first handle, the fixing portion and the extension portion are integrated design.

Preferably, wherein the second handle and the third handle are connected by clamping or fastening;

Preferably, one end of the second handle is provided with internal thread, a connecting portion is provided on one end of the third handle, and outer side wall of the connecting portion is provided with external thread; the detachable connection between the second handle and the third handle can be realized by the cooperation between the external thread on the extension portion and the internal thread on the second handle.

Preferably, the first handle, the second handle and the third handle are all cylindrical.

Preferably, the diameter of one end of the first handle near the fixing portion is smaller than that of another end of the same near the extension portion.

Preferably, the diameter of the extension portion is smaller than that of the first handle.

Preferably, two sides of the extension portion are symmetrically arranged with connecting hole, the hanging ring is fastened in the connecting holes.

Preferably, the functional tools can be brush, shovel or knife.

Preferably, the first handle is made of wood, plastic or silica gel, and the second handle and the third handle are both made of stainless steel.

The invention has following advantageous effects:
the invention provides a portable multifunctional handle with flexible structure, comprising fixedly connected first handle and second handle, one end of the second handle can be detachably connected with third handle, the third handle can be connected to multifunctional tools, such as brush, shovel and knife etc, thereby realizing that various tools share one handle, which not only can save storage space of tools, but also can reduce energy consumption and cost, and relive resource pressure; the diameter of the first handle in the invention is growing bigger from one end near the second handle to another end near the extension portion, which is ergonomic design that is easy to grasp and labor-saving in operation; a fixing portion is provided on the connection position between the first handle and the second handle, the outer side wall of the fixing portion is fixedly connected with a fastening piece, which can prevent the first handle from being damaged by pressure of the second handle when the tool is used, thereby extending the service life of the first handle.

### BRIEF DESCRIPTION OF THE DRAWINGS

FIG. 1 shows whole structure of a portable multifunctional handle in embodiment 1 of the invention.

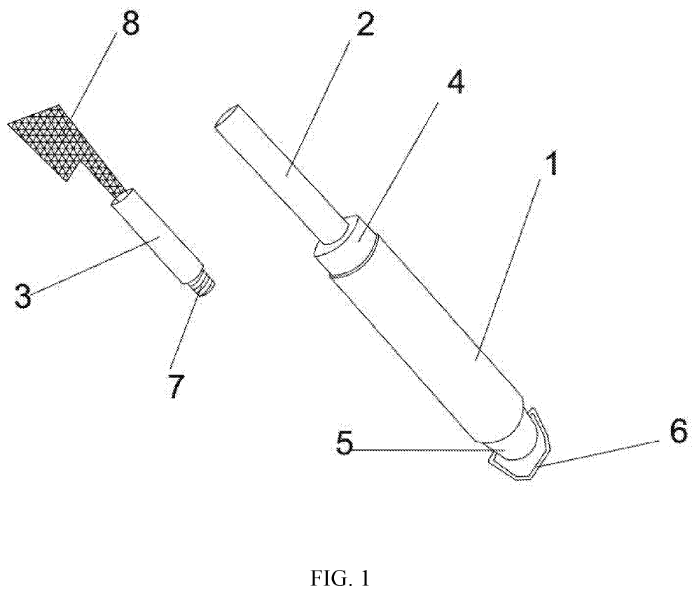

Wherein: 1 refers to first handle; 2 refers to second handle; 3 refers to third handle; 4 refers to fixing portion; 5 refers to extension portion; 6 refers to hanging ring; 7 refers to connecting portion and 8 refers to functional tools.

### BRIEF DESCRIPTION OF THE DRAWINGS

The technical scheme of the invention is further described in details below with reference to accompanying drawings.

A portable multifunctional handle, comprising a first handle 1, one end of the first handle 1 is fixedly connected with a second handle 2, one end of the second end 2 is detachably connected with a third handle 3, one end of the third handle 3 is fixedly connected with functional tools 8; a fixing portion 4 is provided on one end of the first handle 1 near the second handle 2; the outer side wall of the fixing portion 4 is fixedly connected with a fastening piece; an extension portion 5 is fixed on one end of the first handle 1 away from the fixing portion 4, a hanging ring 6 is flexibly arranged on the extension portion 5; the first handle 1, the fixing portion 4 and the extension portion 5 are integrated design.

As a further preferred technical scheme, the second handle 2 and the third handle 3 are connected by clamping, fastening or thread. When they are connected by thread, one end of the second handle 2 is provided with internal thread, a connecting portion 7 is provided on one end of the third handle 3, and outer side wall of the connecting portion 7 is provided with external thread; the detachable connection between the second handle 2 and the third handle 3 can be realized by the cooperation between the external thread on the extension portion 7 and the internal thread on the second handle 2.

Further, the first handle, the second handle and the third handle are all cylindrical; the diameter of one end of the first handle 1 near the fixing portion 4 is smaller than that of another end of the same near the extension portion 5; the diameter of the extension portion 5 is smaller than that of the first handle 1. The first handle 1 is made of wood, plastic or silica gel, and the second handle 2 and the third handle 3 are both made of stainless steel.

Embodiment 1, a portable multifunctional handle, comprising cylindrical first handle 1, second handle 2 and third handle 3. The first handle 1 is made of anti-skid wear-resistant plastic, one end of the first handle 1 is provided with a protruding fixing portion 4, the diameter of the fixing portion 4 is smaller than that of the first handle 1 connected to thereof, the outer side wall of the fixing portion 4 is fixedly connected with a fastening piece, in the embodiment, the fastening piece is a stainless steel shrink ring. The center of the fixing portion 4 is fixedly connected with a second handle 2 made of stainless steel, the second handle 2 is a hollow tubular structure, and one end thereof is provided with internal thread. One end of the second handle 2 is threaded and connected with a third handle 3 made of stainless steel, a connecting portion 7 is provided on one end of the third handle 3, and outer side wall of the connecting portion 7 is provided with external thread, the detachable connection between the second handle 2 and the third handle 3 is realized by the cooperation between the external thread on the extension portion 7 and the internal thread on the second handle 2.

One end of the third handle 3 is fixedly connected with functional tools 8, and the functional tools 8 can be brush, shovel or knife, the existing functional tools can be fixed to the third handle 3 to make different accessories in operation, by reassembling the third handle 3 with different functional tools and the first handle, different complete tools are obtained, which may save storage space of various tools and save costs.

Further, the diameter of one end of the first handle 1 near the fixing portion 4 is smaller than that of another end of the same near the extension portion 5. The overall diameter of the first handle 1 is gradual, which is ergonomic design that is easy to grasp and labor-saving in operation; two sides of the extension portion 5 are symmetrically arranged with connecting hole, the hanging ring 6 is fastened in the connecting holes, the hanging ring 6 can be able to hang the tool to receive convenient storage.

Obviously, the described embodiments are merely individual embodiments of the invention, and not the all embodiments of the invention. Based on the embodiment of the invention, all other implementations, such as changing the material of the first handle or changing the overall shape of the invention structure etc, obtained by those skilled in the art without making creative labor, should be included in the protection scope of the invention.

1. A portable multifunctional handle, comprising a first handle (1), one end of the first handle (1) is fixedly connected with a second handle (2), one end of the second end (2) is detachably connected with a third handle (3), one end of the third handle (3) is fixedly connected with functional tools (8);
a fixing portion (4) is provided on one end of the first handle (1) near the second handle (2); the outer side wall of the fixing portion (4) is fixedly connected with a fastening piece, an extension portion (5) is fixed on one end of the first handle (1) away from the fixing portion (4), a hanging ring (6) is flexibly arranged on the extension portion (5);
the first handle (1), the fixing portion (4) and the extension portion (5) are integrated design.

2. The portable multifunctional handle of claim 1, wherein the second handle (2) and the third handle (3) are connected by clamping or fastening;

3. The portable multifunctional handle of claim 1, wherein one end of the second handle (2) is provided with internal thread, a connecting portion (7) is provided on one end of the third handle (3), and outer side wall of the connecting portion (7) is provided with external thread; the detachable connection between the second handle (2) and the third handle (3) can be realized by the cooperation between the external thread on the extension portion (7) and the internal thread on the second handle (2).

4. The portable multifunctional handle of claim 1, wherein the first handle, the second handle and the third handle are all cylindrical.

5. The portable multifunctional handle of claim 1, wherein the diameter of one end of the first handle (1) near the fixing portion (4) is smaller than that of another end of the same near the extension portion (5).

6. The portable multifunctional handle of claim 1, wherein the diameter of the extension portion (5) is smaller than that of the first handle (1).

7. The portable multifunctional handle of claim 1, wherein two sides of the extension portion (5) are symmetrically arranged with connecting hole, the hanging ring (6) is fastened in the connecting holes.

8. The portable multifunctional handle of claim 1, wherein the functional tools (8) can be brush, shovel or knife.

9. The portable multifunctional handle of claim 1, wherein the first handle (1) is made of wood, plastic or silica gel, and the second handle (2) and the third handle (3) are both made of stainless steel.
